(19) United States
(12) Patent Application Publication
(10) Pub. No.: US 2025/0295221 A1
(43) Pub. Date: Sep. 25, 2025

(54) COMBINATION HAMMER/TOOL HOLDER

(71) Applicant: Michael Wertman, Wharton, NJ (US)

(72) Inventor: Michael Wertman, Wharton, NJ (US)

(21) Appl. No.: 19/086,905

(22) Filed: Mar. 21, 2025

Related U.S. Application Data
(60) Provisional application No. 63/568,106, filed on Mar. 21, 2024.

(51) Int. Cl. A45F 5/02; A45F 5/00; F16B 45/02

(52) U.S. Cl. CPC A45F 5/021; A45F 5/1575; F16B 45/023; F16B 45/024; F16B 45/029

(57) ABSTRACT

A tool support device includes a backer having a planar surface; a hammer support bar, the hammer support bar having a first portion extending perpendicular to the planar surface and a second portion attached to the planar surface such that the hammer support bar and the backer form an open hammer support area; an accessory support bar extending parallel to the first portion of the hammer support bar and being associated with the hammer support bar, the accessory support bar and the open hammer support bar forming an open accessory area outside the bounds of the open hammer support area. The open hammer support area supports the head of a hammer while the handle of the hammer is passed therethrough and the open accessory area permits a clip to be clipped onto the accessory support bar. A spring loaded clip specifically configured for this purpose may also be provided.

### CROSS-REFERENCE TO RELATED APPLICATIONS

The present application claims the benefit of U.S. Provisional Application Ser. No. 63/568,106 filed Mar. 21, 2024, entitled “COMBINATION HAMMER/TOOL HOLDER” the disclosure of which is hereby incorporated by reference herein.

### BACKGROUND OF THE INVENTION

It is well known that construction workers need to utilize multiple tools sequentially, and repeatedly. For example, wood structure framers are often required to use a staple hammer tacker (hereinafter referred to as a “staple whacker”) to secure moisture resistant barriers to wooden sheathing to build an exterior system of homes, all the while being elevated at height on a ladder. Often, the framer will come across a nail that is not fully secured within the sheathing upon which the barrier is installed and will therefore be required to secure the staple whacker safely while drawing a hammer to drive the nail fully. It will be appreciated that a right-handed framer will keep his or her left hand secured to the ladder (or at least available to grab the ladder) while making the tool exchange or attempting to make the tool exchange-one handed with the right hand. This can be a dangerous and time-consuming situation.

Other combinations of tools are also required sequentially and repeatedly. These include the combination of hammers and air tools such as either framing or finish nail guns. Another example that is often required are hammers and screw guns.

### SUMMARY OF THE INVENTION

It would therefore be advantageous for a construction worker to have devices available for storing multiple construction tools on a belt supported holder for quick and convenient holstering, access, and subsequent re holstering, all one handed.

In one embodiment of the present invention, a COMBINATION HAMMER/TOOL HOLDER comprises a backer having a planar surface, a hammer support bar, the hammer support bar having a first portion extending perpendicular to the planar surface of the backer and a second portion attached to the planar surface such that the hammer support bar and the backer form an open hammer support area; and an accessory support bar extending parallel to the first portion of the hammer support bar and being associated with the hammer support bar, the accessory support bar and the open hammer support bar forming an open accessory area outside the bounds of the open hammer support area. In this embodiment, the open hammer support area is adapted to support the head of a hammer while the handle of the hammer is passed therethrough and the open accessory area is adapted to permit a clip to be clipped onto the accessory support bar.

In the tool support device of the first embodiment, the first portion of the hammer support may include a semicircular section.

The accessory support bar may be U-shaped.

The accessory support bar may be welded to the hammer support bar.

The first portion of the hammer support bar may have a circular cross section.

In the tool support device of the first embodiment, the hammer support bar and the accessory support bar may be monolithic.

In the tool support device of the first embodiment, the device may further include a tertiary support bar, the tertiary support bar spanning between the hammer support bar and the accessory support bar to divide the open accessory area into an open whacker area and a tertiary open area.

The open whacker area may be larger than the tertiary open area.

In the tool support device of the first embodiment, the device may further include a clip, the clip having a connection portion for connecting to a tool and an attachment portion for attaching to the accessory support bar, the attachment portion having an open area enclosable by a spring bar forming a gate, the spring bar having a biased closed position enclosing the open area.

The spring bar may be moved into an open position allowing access to the open area.

The connection portion may include an aperture sized and configured to accept a threaded portion of a pneumatic air barb of the tool.

The attachment portion may include an extension member forming a spike, the spike extending into the open area.

In the tool support device of the first embodiment, the device may further include a clip, the clip having a connection portion for connecting to a tool and an attachment portion for attaching to the accessory support bar, the attachment portion having an open area enclosable by a spring bar forming a gate, the spring bar having a biased closed position enclosing the open area; and the spring bar may be moved into an open position allowing access to the open area.

The connection portion may be sized and configured to replace a belt clip of a conventional tool, including having a portion sized and configured for insertion into the conventional tool and an aperture sized and configured to accept a fastener insertable into an existing threaded barrel of the conventional tool.

In the tool support device of the first embodiment, the device may further include a clip, the clip having a connection portion for connecting to a tool and an attachment portion for attaching to the accessory support bar, the attachment portion having an open area enclosable by a spring bar forming a gate, the spring bar having a biased closed position enclosing the open area; and the spring bar may be moved into an open position allowing access to the open area. The attachment portion may include a semicircular capture portion for capturing the accessory support bar.

In the tool support device of the first embodiment, the device may further include a clip, the clip having a connection portion for connecting to a tool and an attachment portion for attaching to the accessory support bar, the attachment portion having an open area enclosable by a spring bar forming a gate, the spring bar having a biased closed position enclosing the open area; and the spring bar may be moved into an open position allowing access to the open area. The attachment portion may include a built up area forming a semicircular capture portion for capturing the accessory support bar.

In a further embodiment of the present invention, a kit for supporting a plurality of tools upon a user's belt may include a support device, the support device including a backer having a planar surface; a hammer support bar, the hammer support bar having a first portion extending perpendicular to the planar surface and a second portion attached to the planar surface such that the hammer support bar and the backer form an open hammer support area; and an accessory support bar extending parallel to the first portion of the hammer support bar and being associated with the hammer support bar, the accessory support bar and the open hammer support bar forming an open accessory area outside the bounds of the open hammer support area; a clip, the clip including a connection portion for connecting to a tool and an attachment portion for attaching to the accessory support bar, the attachment portion having an open area enclosable by a spring bar forming a gate, the spring bar having a default closed position enclosing the open area and an open position permitting access to the open area. In the further embodiment, the open hammer support area may be adapted to support the head of a hammer while the handle of the hammer is passed therethrough and the open accessory area may be adapted to permit the clip to be secured onto the accessory support bar by moving the spring bar into the open position.

The support device may further include a tertiary support bar dividing the open accessory area into two areas.

The tertiary support bar may split the open accessory area into two unequally sized areas.

In the further embodiment of the present invention, the support device may further include a tertiary support bar dividing the open accessory area into two areas, and the connection portion of the clip may include an aperture sized and configured to accept a threaded portion of a pneumatic air barb of a conventional tool.

In the further embodiment of the present invention, the support device may further include a tertiary support bar dividing the open accessory area into two areas, and the connection portion may be sized and configured to replace a belt clip of a conventional tool, including having a portion sized and configured for insertion into the conventional tool and an aperture sized and configured to accept a fastener insertable into an existing threaded barrel of the conventional tool.

In an additional embodiment of the present invention, a tool clip includes a connection portion for connecting to a tool and an attachment portion for attaching the tool clip to a component, the attachment portion having an open area enclosable by a spring bar forming a gate, the spring bar having a biased closed position enclosing said open area.

In the additional embodiment of the present invention, the connection portion may include an aperture sized and configured to accept a threaded portion of a pneumatic air barb of a tool such that the connection portion of the tool clip may be sandwiched between a tool and a washer portion of the pneumatic air barb to secure the connection portion to the tool.

In the additional embodiment of the present invention, the connection portion may include a flattened capture portion sized and configured to be inserted into a receptacle of a tool; an aperture through a surface perpendicular to the flattened capture portion, the aperture sized and configured to accept a fastener securable within an existing threaded barrel of the tool to secure the capture portion to the tool.

### BRIEF DESCRIPTION OF DRAWINGS

The subject matter regarded as the invention is particularly pointed out and distinctly claimed in the concluding portion of the specification. The invention, however, both as to organization and method of operation, together with features, objects, and advantages thereof, will be or become apparent to one with skill in the art upon reference to the following detailed description when read with the accompanying drawings. It is intended that any additional organizations, methods of operation, features, objects or advantages ascertained by one skilled in the art be included within this description, be within the scope of the present invention, and be protected by the accompanying claims.

With respect to the drawings, FIG. 1A is a perspective view of a hammer holder as known in the prior art;

FIG. 1B is a perspective view of the hammer holder of FIG. 1, with a hammer secured there, also as known in the prior art;

FIG. 2 is a perspective view of a COMBINATION HAMMER/TOOL HOLDER, referred to in this embodiment as a double hammer holder, in accordance with a first embodiment of the present invention;

FIG. 3 is a frontal view of the double hammer holder of FIG. 2;

FIG. 4 is a side view of the double hammer holder of FIG. 2;

FIGS. 5 and 6 are top views of the double hammer holder of FIG. 2;

FIG. 7 is a perspective view of a COMBINATION HAMMER/TOOL HOLDER, referred to in this embodiment as a hammer whacker holder, in accordance with a second embodiment of the present invention;

FIG. 8 is a frontal view of the hammer whacker holder of FIG. 7;

FIG. 9 is a side view of the hammer whacker holder of FIG. 7;

FIGS. 10 and 11 are top views of the hammer whacker holder of FIG. 7;

FIG. 12 is a perspective view of the hammer whacker holder of FIG. 7 supporting both a hammer and a staple whacker;

FIG. 13 is a side view of the hammer whacker holder of FIG. 7 supporting only a staple whacker;

FIG. 14 is a perspective view of a large air hose clip in accordance with a third embodiment of the present invention;

FIG. 15 is a side view of the large air hose clip of FIG. 14;

FIG. 16 is a side view of the large air hose clip of FIG. 14;

FIG. 17 is a top view of the large air hose clip of FIG. 14;

FIG. 18 is a side view of the large air hose clip of FIG. 14;

FIG. 19 is a side view of the large air hose clip of FIG. 14 mounted on the pneumatic air barb a framing nailer;

FIG. 20 is perspective view of a small air hose clip in accordance with a fourth embodiment of the present invention;

FIG. 21 is a side view of the small air hose clip shown in FIG. 20, with the spring bar shown in the closed position;

FIG. 22 is a side view of the small air hose clip shown in FIG. 20, with the spring bar shown in the open position;

FIG. 23 is a perspective view a battery powered screw gun clip in accordance with a fifth embodiment of the present invention;

FIG. 24 is a side view of the battery powered screw gun clip of FIG. 23;

FIG. 25 is a frontal view of the battery powered screw gun clip of FIG. 23;

FIG. 26 is a top view of the battery powered screw gun clip of FIG. 23;

FIG. 27 is a perspective view of the battery powered screw gun clip of FIG. 23 mounted to a conventional screw gun; and,

FIG. 28 is a perspective view of the battery powered screw gun clip of FIG. 23 mounted to a conventional screw gun as shown in FIG. 27, clipped to the double hammer holder of FIG. 2.

### DETAILED DESCRIPTION OF THE INVENTION

In the following are described the preferred embodiments of the COMBINATION HAMMER/TOOL HOLDER in accordance with the present invention. In describing the embodiments illustrated in the drawings, specific terminology will be used for the sake of clarity. However, the invention is not intended to be limited to the specific terms so selected, and it is to be understood that each specific term includes all technical equivalents that operate in a similar manner to accomplish a similar purpose. Where like elements have been depicted in multiple embodiments, identical reference numerals have been used in the multiple embodiments for ease of understanding.

Throughout this disclosure reference is made to a staple hammer tacker, or “staple whacker.” Staple whackers are well known in the construction industry, and include devices such as the DeWALT® Heavy-Duty Hammer Tacker and the Arrow® HT50 Professional Hammer Tacker, both currently marketed commercially. DeWALT® is a registered trademark of The Black & Decker Corporation of Towson, Maryland, and Arrow® is a registered trademark of the Arrow Fastener Co., LLC of Saddle Brook, New Jersey.

Hammers are also referred to and are ubiquitous in the construction industry. These hammers may include framing hammers, such as the 22 oz. Milled Face Framing Hammer marketed by Milwaukee®, general purpose hammers such as Milwaukee's 19 oz. Smooth Face Poly/Fiberglass Handle Hammer, or other types of hammers. Milwaukee® is a registered trademark of Milwaukee Electric Tool Corporation of Brookfield, Wisconsin.

Reference is also made to nail guns. These include framing nail guns and finish nail guns, both being compressed air driven. Examples of these devices include the Porter-Cable® 21-Degree 3½ in. Full Round Framing Nailer or the DeWalt® 18-Guage Pneumatic Brad Nailer. Porter-Cable® is a registered trademark of The Black & Decker Corporation of Towson, Maryland.

Finally, reference is made to screw guns. Various screw guns and screw gun types may be utilized, provided they include means for securing the clip of the present invention. One example is the Makita® 18V LXT Lithium-Ion Brushless Cordless Drywall Screwdriver with Push Drive Technology. Makita® is a registered trademark of Makita Corporation, 3-11-8, Sumiyoshi-cho, Anjo-shi Aichi 446-8502, Japan. The term “screw guns” shall be understood to also include drill drivers, impact drivers, and hammer drills, such as the DeWALT® 20V MAX Cordless ½ in. Drill/Driver and the like.

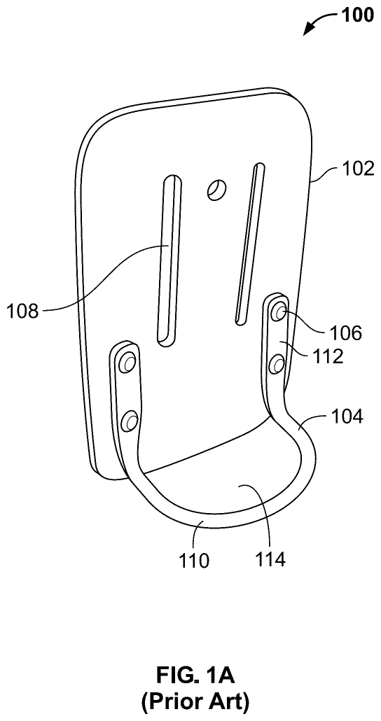

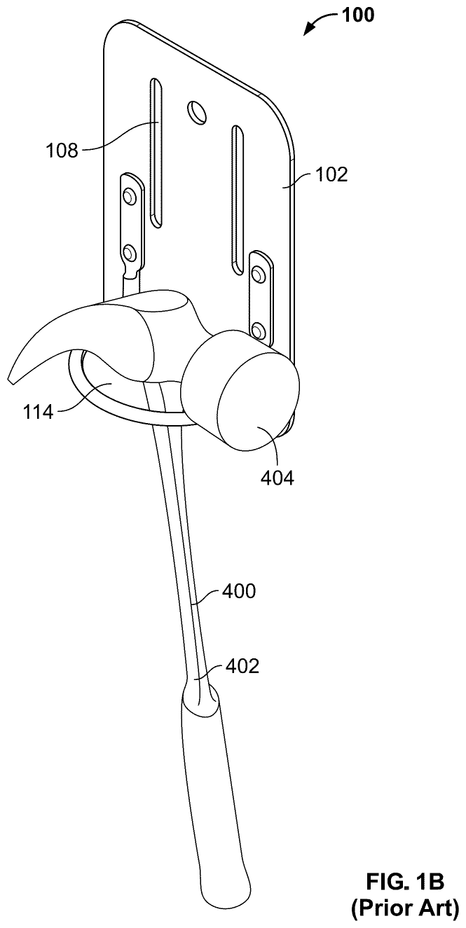

It is well known in the prior art that hammers, again including framing hammers, general purpose hammers, or other hammers, may be stored on a belt mounted carrier. One such prior art example is shown in FIG. 1A. There, the belt mounted hammer holder 100 comprises a generally planar leather backer 102 with a hammer support bar 104 mounted thereto. In this example, the hammer support bar is mounted via four rivets 106. The backer 102 includes a pair of opposed slots through which a belt may be threaded, such that the hammer holder 100 may be fully supported by the belt in an orientation where the generally planar is vertical.

It will be appreciated that the metal hammer support bar 104 forms a semicircular area 110 which is perpendicular to the generally planar backer 102, such that the semicircular area of the hammer support bar is horizontal when the hammer holder 100 is mounted on a belt. Extending from each end of the semicircular area 110, and being curved to match the orientation of the backer 102, are two flattened bars 112. It is these flattened bars 112 through which the four rivets 106 are provided. In other prior art hammer holders, there may only be a single flattened bar.

This arrangement creates an open hammer area 114 where the handle 402 of a hammer 400 may be placed to support the hammer on a user's belt through the hammer holder 100, via the head 404 of the hammer being larger than the open hammer area 114, as shown in FIG. 1B.

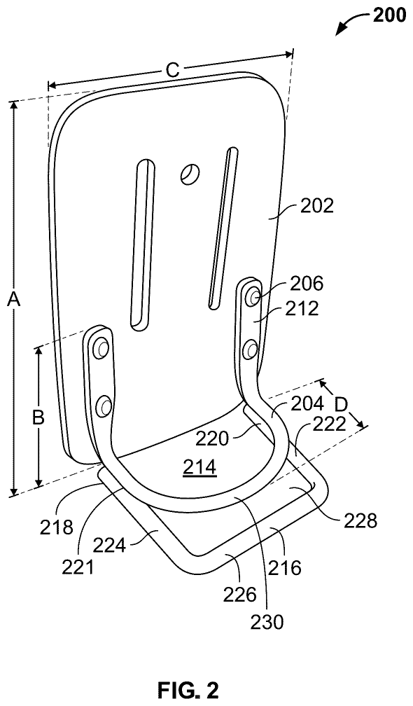

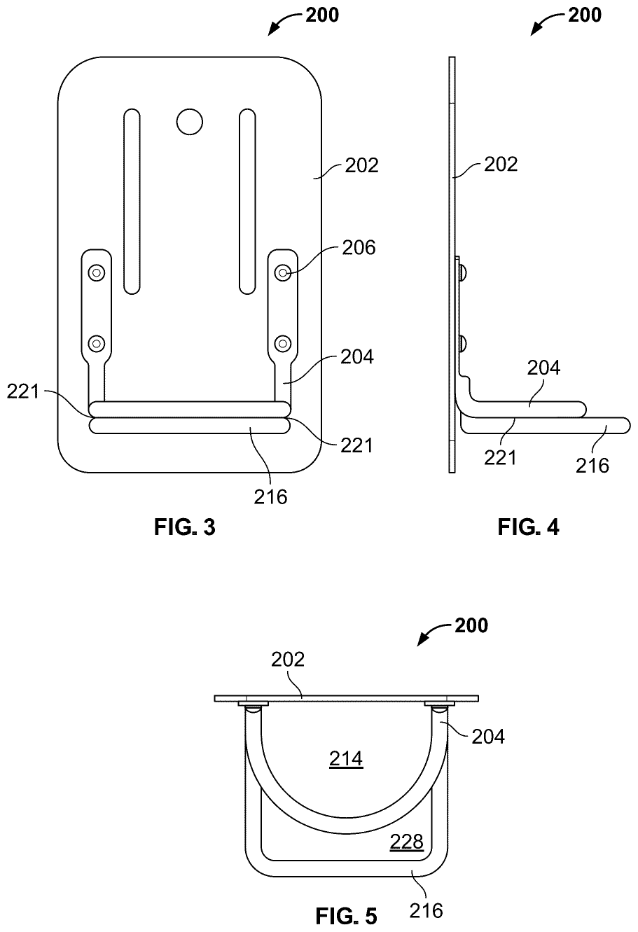

In accordance with a first embodiment of the invention, shown in FIGS. 2-6 an inventive double hammer holder 200 includes similar features of the prior art hammer holder 100, including the backer 202, hammer support bar 204, and rivets 206, with the addition of an accessory support bar 216. In this embodiment, and where the bars are metal, the accessory support bar 216 is welded to the hammer support bar 204. However, both bars could be formed together as a monolithic unit either of metal or other material. These bars preferably are provided with circular cross sections but other arrangements, such as oval or square, may be provided.

The accessory support bar 216 is shown as a U-shaped bar with its ends 218, 220 welded to the hammer support bar 204 in the areas where the hammer support bar curves to match the orientation of the backer 202, referred to as welded areas 221. The accessory support bar 216 includes first and second legs 222, 224, with a connection member 226 therebetween. The legs 222, 224 are of such a length that they extend beyond the physical limits of the hammer support bar 104, and therefore the open hammer area 214, to form an open accessory area 228 in conjunction with the connection member 226. The open accessory area 228 provides clearance for a clip, as will be discussed, to be mounted on the accessory support bar 216.

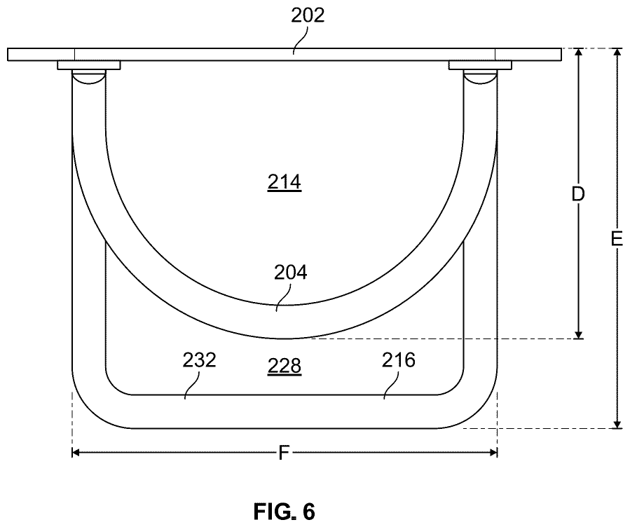

The preferred dimensions of the double hammer holder 200 are discussed in relation to FIGS. 2 and 6. These dimensions represent one possible configuration, and it will be appreciated that other dimensions may be, and in fact are, suitable for the device.

As shown in FIG. 2, the height of the backer 202, represented by dimension “A,” may be 164 mm, the height of the hammer support bar vertically up the backer, represented by dimension “B,” may be 70 mm, and finally the width of the backer, represented by dimension “C,” may be 110 mm. The depth of the hammer support bar 204, identified as the distance of its distal portion 230 from the backer 202, as represented by dimension “D,” may be 51 mm. The diameter of the hammer support bar 304 itself may be 6 mm.

Moving to FIG. 6, the depth of the accessory support bar 216, identified as the distance of its distal portion 232 from the backer 202, as represented by dimension “E,” may be 64 mm. Finally, the width of the accessory support bar 216, as represented by dimension “F,” may be 78 mm.

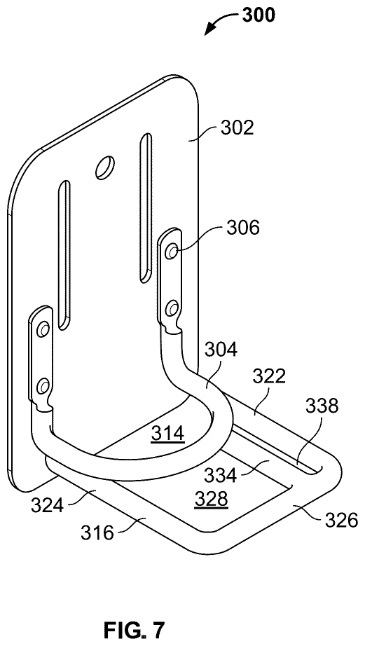

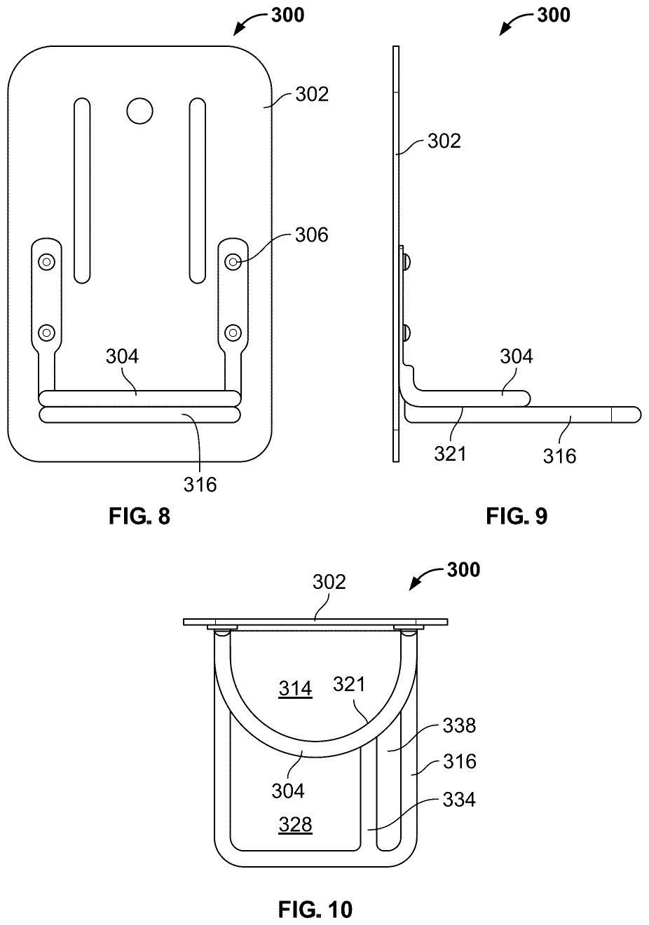

FIGS. 7-9 depict various views of a second embodiment of the present invention. In this embodiment, an inventive hammer whacker holder 300 is provided. The hammer whacker holder 300 includes many of the features of the prior art hammer holder 100, including the backer 302, hammer support bar 304, and rivets 306, with the addition of a whacker support bar 316. The whacker support bar 316 is similar in shape to the accessory support bar 226, but the length of its legs 322, 324 are longer such that its connection member 326 is further from the backer 302 that in the prior embodiment. While the open hammer area 314 remains the same, this increased leg length provides a larger open accessory area 328. The open accessory area 328 is bordered by the hammer support bar 304, the whacker support bar 316, and a tertiary bar 334, the tertiary bar spanning between the connection member 326 and the hammer support bar 304. It will be appreciated that the tertiary bar 334 preferably does not split the connection member 326 evenly, but rather is skewed toward one side such that a tertiary open area 338 is formed and is much smaller than the open accessory area 328. It is preferred that that open accessory area 328 be large enough to fit the handle of a staple whacker, yet small enough to capture its head, as will be discussed. As shown in FIG. 9, the whacker support bar 316 is welded to the hammer support bar 304 in weld areas 321. The various bars may also be formed monolithically.

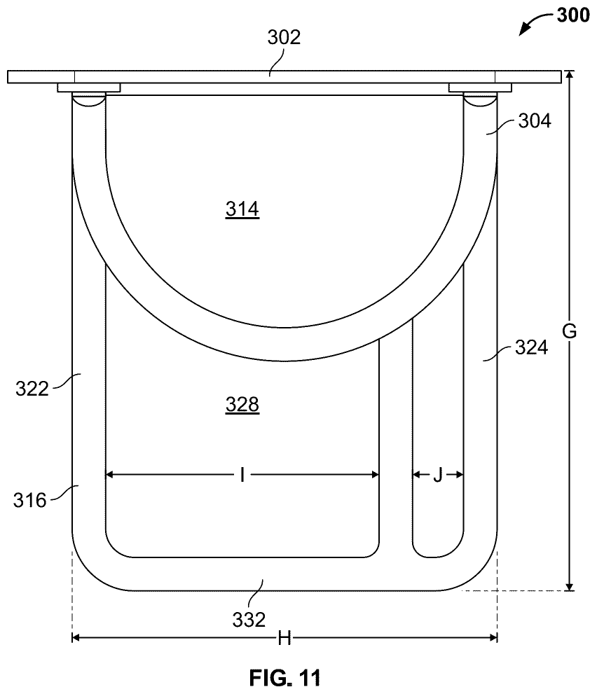

The preferred dimensions of the hammer whacker holder 300 are discussed in relation to FIG. 11. These dimensions represent one possible configuration, and it will be appreciated that other dimensions may be, and in fact are, suitable for the device. Before discussing these dimensions, it will be appreciated that like elements from other embodiments may be identical. For example, the backer 302 may have dimensions of 164 mm by 110 mm. Likewise, the depth of the hammer support bar 304 may be 51 mm. The diameter of the hammer support bar 304 itself may be 6 mm. Again, other dimensions may be provided.

Moving to FIG. 11, the depth of the whacker support bar 316, identified as the distance of its distal portion 332 from the backer 302, as represented by dimension “G,” may be 93 mm. The width of the whacker support bar 316, as represented by dimension “H,” may be 78 mm. Finally, the clear span of the open accessory area 328, represented by dimension “I,” may be 49 mm while the clear span of the tertiary open area 338, represented by dimension “J,” may be 11 mm. Given the 49 mm clear span of the open accessory area 328, and the 11 mm clear span of the open tertiary area 338, together with three 6 mm bars (i.e. legs 322, 324 and tertiary bar 334, yields a total dimension of 78 mm, e.g. dimension “H.”

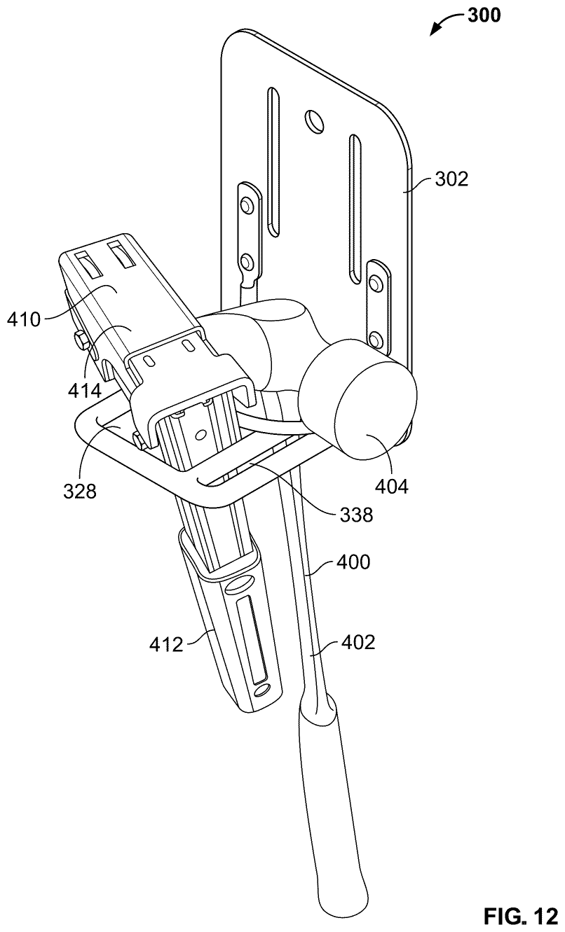

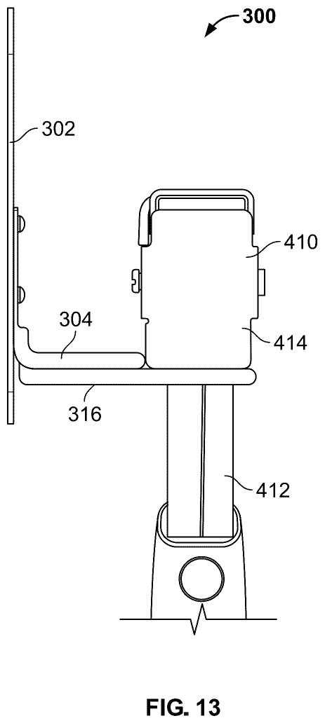

FIG. 12 depicts one manner of using the hammer whacker holder 300. Here, a hammer 400 is shown with its handle 402 extended through the open hammer area 314. This effectively captures the head 404 of the hammer 400, such that the hammer is supported and stored. This is quite similar to how the prior art hammer holder 100 of FIGS. 1A and 1B may be utilized. However, in addition thereto, hammer whacker holder 300 also permits support and storage of a staple whacker 410. Here, the handle 412 of the staple whacker 410 may be placed within the open accessory area 328 and inserted until the head 414 of the staple whacker is captured by the whacker support bar 316, thus securing the staple whacker in place. It will be appreciated that a user of the whacker holder 300 may easily and readily remove either the hammer 400 or the staple whacker 410 with one hand while the other tool remains supported and stored. Reinsertion of the removed tool is similarly achieved with one hand. FIG. 13 depicts a whacker holder 300 with a staple whacker 410 inserted, and a hammer (not shown) removed.

It will be appreciated that the tertiary open area 338 remains open and available at all times, even with both a hammer 400 and staple whacker 410 stowed. Its use, as a support for a clip, will be described further below. It is noted here, however, that such use is similar to the usage of open accessory area 228 with respect to double hammer holder 200. In that regard, various clips may be utilized to support other tools, such as pneumatic nail guns or battery operated screw guns.

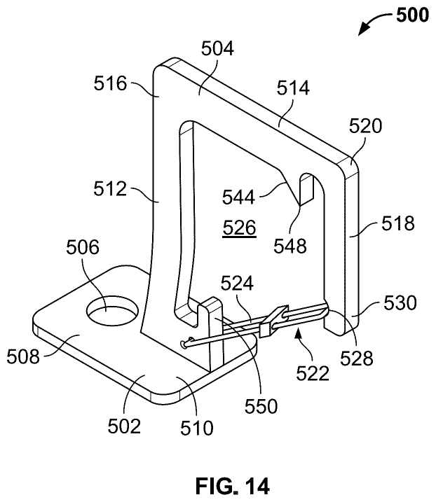

One such clip, referred to herein as a large air hose clip 500, is shown in FIGS. 14-17. Large air hose clip 500 is particularly configured for use with a pneumatic framing nailer and includes features, such as its size, particular to use by framers. In one embodiment, the inventive large air hose clip 500 includes a connection plate 502 and an attachment portion 504. It will be appreciated that the connection plate 502 is designed to connect to a tool, particularly a compressed air driven tool, while the attachment portion 504 is designed to subsequently attach, and detach, from either the hammer holder 200 or the hammer whacker holder 300, and particularly either the accessory support bar 216 or the whacker support bar 316. Incidentally, the attachment portion 504 may also attach, and detach, from the hammer support bar 104 of the hammer holder 100, but generally not easily when a hammer is also stored in the open hammer area 114. Thus, the inventive hammer holder 200 and the hammer whacker holder 300 provide greater utility than the hammer holder 100 of the prior art.

Moving back to the large air hose clip 500 shown in FIGS. 14-17, it will be appreciated that in one embodiment the connection plate 502 is planar, with a circular aperture 506 provided in a first section 508. In the meantime, a second section 510 has the attachment portion 504 mounted thereto.

The attachment portion 504 may be configured to many shapes and sizes suitable for mounting on the various bars described herein, such as the accessory support bar 216. In this embodiment, the attachment portion 504 is somewhat U-shaped and is provided with a first leg 512 connected to the connection plate 502, a second leg 514 extending perpendicular to a distal portion 516 of the first leg, opposite the connection plate, and a third leg 518 extending perpendicular from a distal portion 520 of the second leg 514, making it parallel to the first leg 512. This arrangement leaves an opening 522 between the first leg 512 and the third leg 518. The opening 522 is sized and configured to permit entry of the various bars described herein, such as the accessory support bar 216, and may be provided with a spring bar 524, forming a gate, for permitting or denying entry of the bars into the opening. Beyond the opening 522, and within the confines of the attachment portion 504, is a well area 526.

While the various legs of the attachment portion 504 are shown in the figures as squared, it will be appreciated that they may be configured to other suitable shapes, such as round, oval, or square with softened edges.

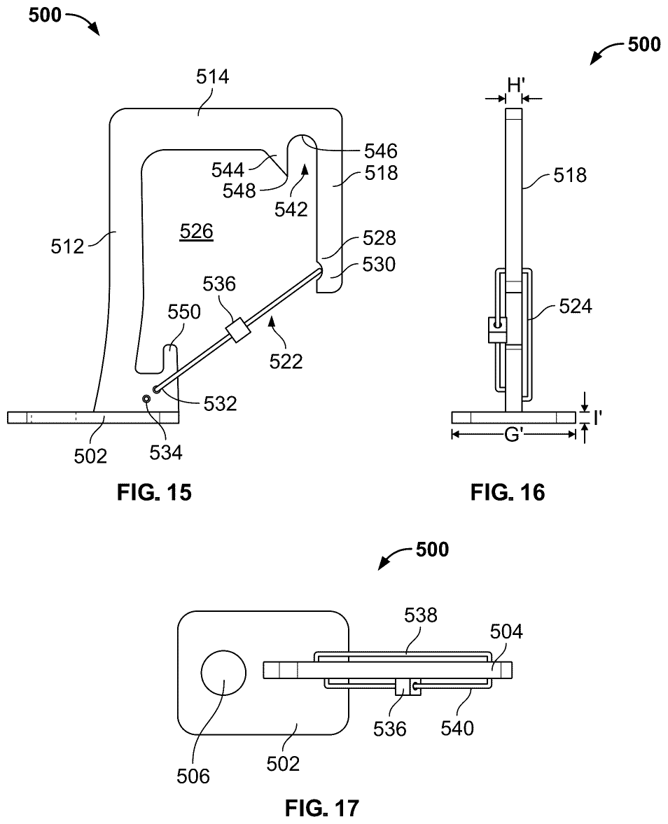

Referring back to the spring bar 524, it will be appreciated that in a first position, shown in FIG. 14, the spring bar will deny exiting of the various bars described herein, such as the accessory support bar 216, from within the well area 526. This is achieved by virtue of recess 528 within the distal end 530 of the third bar 518 which blocks rotation of the spring bar 524 in the clockwise direction as shown in the orientation of FIG. 15. Alternate means of preventing rotation such as a stop block may also be provided. The spring bar 524 is naturally kept snug against the recess 528 (or other means) as the spring bar is provided in spring loaded form, by virtue of its offset mounting holes 532, 534, which support each end of the looped shaped wire forming the spring bar 524. In other embodiments the spring bar 524 may be accompanied by an actual spring.

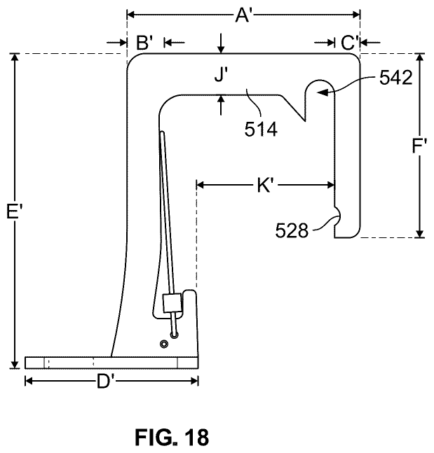

To move the spring bar 524 to the open position, shown in FIG. 18, a user must purposefully move the spring bar 524 in the counter-clockwise direction, against its natural bias pressing against the recess 528. This can be achieved either by hand, or through the assertion of pressure against the spring bar 524, such as pressure that can be achieved by pressing the spring bar against a bar of the inventive device, particularly either the accessory support bar 216 or the whacker support bar 316. Once the bar (e.g. accessory support bar 216 or whacker support bar 316) passes the opening 522 and enters the well 526, the spring bar 524 will naturally bias back into the closed position against the recess 528 to secure the bar within the well. The spring bar 524 may be provided with a slide mechanism 536 to help with grasping the spring bar as well as to prevent the legs of the bar 538, 540 from spreading. This slide mechanism 536 may also serve to lock the spring bar 524 to an extension member 550 positioned adjacent to the first leg 512, effectively securing the spring bar in the open position.

To prevent a secured bar (e.g. accessory support bar 216 or whacker support bar 316) from moving freely within the confines of the well 526, the second leg 514 may be provided with a bar stabilizer area 542 formed between the second leg 514, third leg 518, and an extension member 544 extending into the well from the second leg. Preferably, this arrangement forms a semicircular capture portion 546 which is just slightly larger than the diameter of the bar designed to be captured, such as either the accessory support bar 216 or the whacker support bar 316. By way of example, for a 6 mm bar, the diameter of the semicircular capture portion 546 may be 8 mm. The capture portion 546 may also be configured to other shapes, such as square or oval, preferably corresponding to the shape of the bar to be captured.

Although other dimensions may be used successfully, in one embodiment the large air hose clip 500 may have the following dimensions:
A′-66 mm
B′-9 mm
C′-7 mm
D′-50 mm
E′-89 mm
F′-52 mm
G′-35 mm
H′-4 mm
I′-4 mm
J′-10 mm
K′-41 mm
Aperture 506-14 mm diameter

It will be appreciated that given those dimensions, standard “2-by” lumber (that is, lumber having a 1.5 in. nominal dimension in one direction) will fit within the well 526 such that the large air hose clip 500 may be stored on upstanding lumber, such as 2 in.×10 in. or 2 in.×12 in. rafters. Extension member 544 may terminate in a spike 548, such that when fitted on angled rafters, the spike 548 will engage with the lumber such that the large air hose clip 500 will not slide down the lumber material but will remain in place. Thus, a user's pneumatic nailer remains stationary even when not stowed in a double hammer holder 200 or hammer whacker holder 300. Instead, it may be stowed on the rafter itself via the clip 500. In other embodiments, the spike 548 may be omitted in favor of other means for securing the large air hose clip 500 to the lumber, such as through the use of friction inducing elements. Examples include knurled, ridged, or roughened textures. It will be appreciated that when mounted on such lumber, the spring bar 524 will remain in the open position biased against the side of the lumber member.

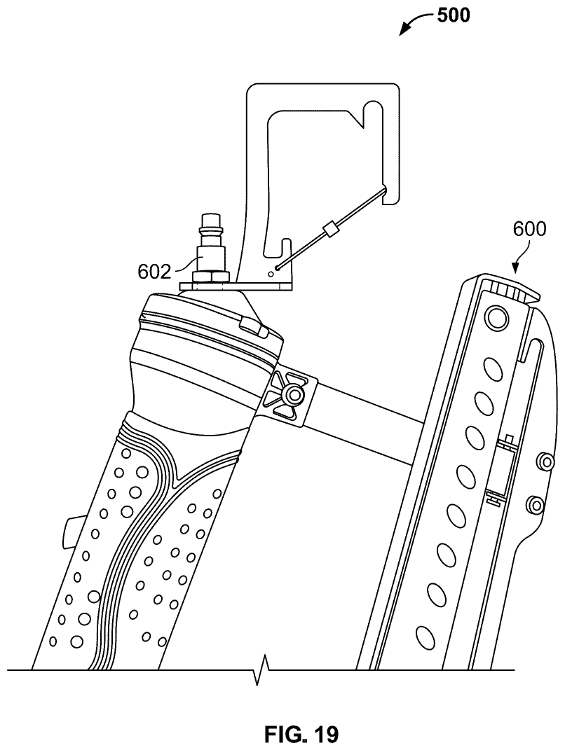

FIG. 19 depicts a preferred method of mounting the large air hose clip 500 to a pneumatic nailer 600. As typical, a nailer 600 includes a pneumatic hose barb 602 for connection to a pneumatic hose (not shown). This barb 602 is commonly threaded into the nailer 600 via a threaded port. To mount the large air hose clip 500 to the nailer 600, one would unthread the barb 602 and place the large air hose clip 500 over the threaded port revealed in the nailer 600, such that the aperture 506 lines up with the port. Then the barb 602 can be rethreaded back into the nailer 600 to sandwich the connection plate 502 of the large air hose clip 500 between the barb and the nailer, effectively holding it in place. It will be appreciated that conventional barbs have threads that are smaller in diameter than a washer portion formed at the proximal end of the threads. Thus the washer area is prevented from passing through the aperture 506 while the threaded portion may pass freely.

It will be appreciated that the spring bar 524 need not be provided, but is provided in certain embodiments as a safety mechanism. That is, when a user is utilizing a tool with the large air hose clip 500, the user is often at elevation, possibly tens of feet above other workers and property. Being able to securely clip a tool to ones belt, via either the hammer holder 200 or the hammer whacker holder 300, or to a rafter, helps ensure that the tool is not dropped on other workers or property. Locking the clip provides even more security than an open U-configured clip would.

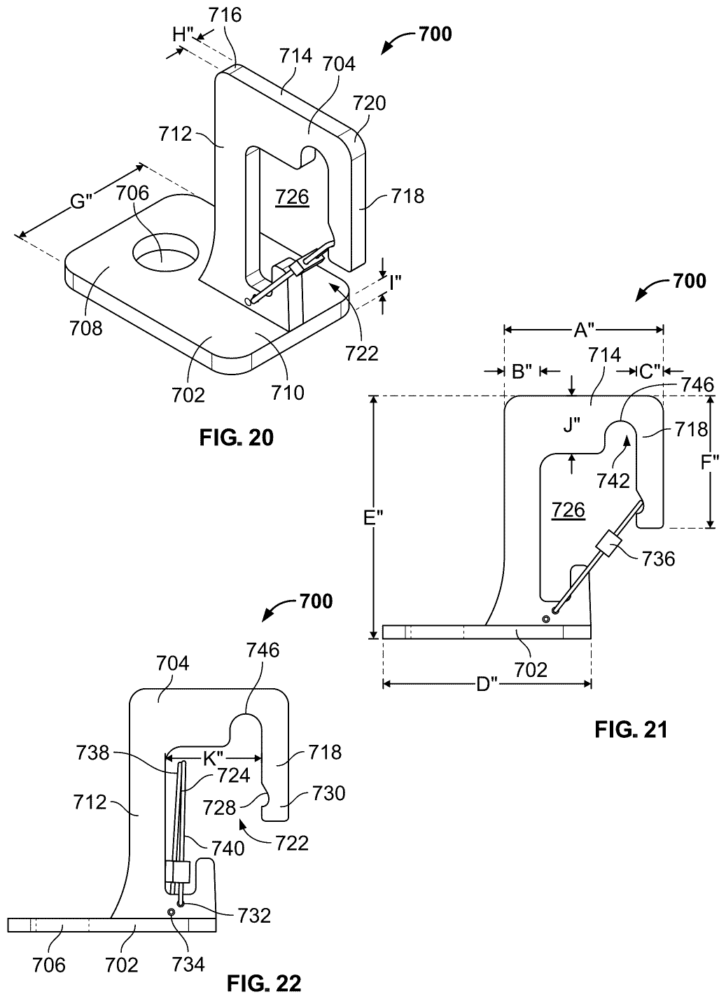

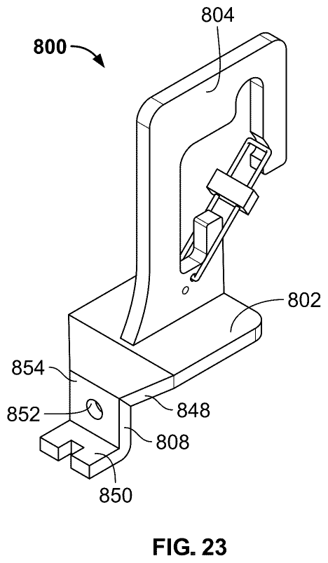

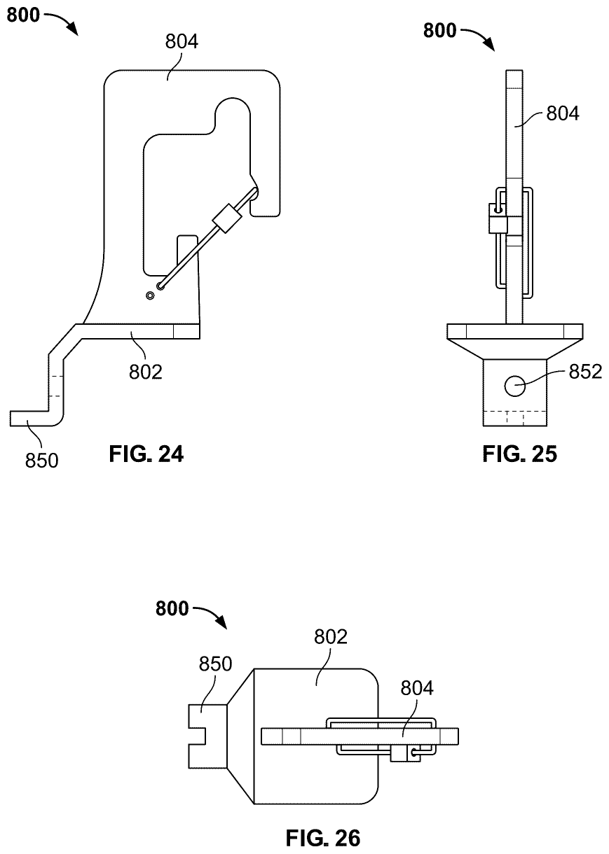

A second clip referred to herein as a small air hose clip 700, is shown in FIGS. 20-22. Small air hose clip 700 is particularly configured for use with a pneumatic finish nailer, which one will appreciate is generally physically smaller than a framing nailer. In one embodiment, the inventive small air hose clip 700 includes a connection plate 702 and an attachment portion 704. It will be appreciated that the connection plate 702 is designed to connect to a tool, particularly a compressed air driven tool, while the attachment portion 704 is designed to subsequently attach, and detach, from either the hammer holder 200 or the hammer whacker holder 300, and particularly either the accessory support bar 216 or the whacker support bar 316. Incidentally, the attachment portion 704 may also attach, and detach, from the hammer support bar 104 of the hammer holder 100, but generally not easily when a hammer is also stored in the open hammer area 114. Thus, the inventive hammer holder 200 and the hammer whacker holder 300 provide greater utility than the hammer holder 100 of the prior art.

Moving back to the small air hose clip 700 shown in FIGS. 20-22, it will be appreciated that in one embodiment the connection plate 702 is planar, with a circular aperture 706 provided in a first section 708. In the meantime, a second section 710 has the attachment portion 704 mounted thereto.

The attachment portion 704 may be configured to many shapes and sizes suitable for mounting on the various bars described herein, such as the accessory support bar 216. In this embodiment, the attachment portion 704 is somewhat U-shaped and is provided with a first leg 712 connected to the connection plate 702, a second leg 714 extending perpendicular to a distal portion 716 of the first leg, opposite the connection plate, and a third leg 718 extending perpendicular from a distal portion 720 of the second leg 714. Thus the third leg 718 is parallel to the first leg 712. This arrangement leaves an opening 722 between the first leg 712 and the third leg 718. The opening 722 is sized and configured to permit entry of the various bars described herein, such as the accessory support bar 216, and may be provided with a spring bar 724 for permitting or denying entry of the bars into the opening. Beyond the opening 722, and within the confines of the attachment portion 704, is a well area 726.

Referring back to the spring bar 724, it will be appreciated that in a first position, shown in FIG. 21, the spring bar will deny exiting of the various bars described herein, such as the accessory support bar 216, from the well area 726. This is achieved by virtue of recess 728 within the distal end 730 of the third bar 718 which blocks rotation of the spring bar 724 in the clockwise direction as shown in the orientation of FIG. 21. The spring bar 724 is naturally kept snug against the recess 728 as it is provided in spring loaded form, by virtue of its offset mounting holes 732, 734 which support each end of the looped shaped wire forming the spring bar 724.

To move the spring bar 724 to the open position, shown in FIG. 22, a user must purposefully move the spring bar 724 in the counter-clockwise direction, against its natural bias against the recess 728. This can be achieved either by hand, or through the assertion of pressure against the spring bar 724, such as pressure that can be achieved by pressing the spring bar against a bar of an inventive device, particularly either the accessory support bar 216 or the whacker support bar 316. Once the bar (e.g. accessory support bar 216 or whacker support bar 316) passes the opening 722 and enters the well 726, the spring bar 724 will naturally bias into the closed position against the recess 728 to secure the bar within the well. The spring bar 724 may be provided with a slide mechanism 736 to help with grasping the spring bar as well as to prevent the legs of the bar 738, 740 from spreading.

To prevent loose movement of the clip 700 relative to the bar, the second leg 714 may be provided with a bar stabilizer area 742 formed within the bounds of the second leg 714, third leg 718, and a built up portion 744 of the second leg 714 extending into the well 726 from the second leg. Preferably, this arrangement forms a semicircular capture portion 746 which is just slightly larger than the diameter of the bar designed to be captured, such as either the accessory support bar 216 or the whacker support bar 316. By way of example, for a 6 mm bar, the diameter of the semicircular capture portion 546 may be 8 mm. Other shapes such as square or oval may be provided to accommodate round or other shaped bars.

Although other dimensions may be used successfully, in one embodiment the small air hose clip 700 may have the following dimensions:
A″-39 mm
B″-9 mm
C″-7 mm
D″-50 mm
E″-60 mm
F″-32 mm
G″-35 mm
H″-4 mm
I″-4 mm
J″-14 mm
K″-23 mm
Aperture 706-14 mm diameter

Although not shown, it will be appreciated that the small air hose clip 700 may attach to a nailer in a manner similar to that of large air hose clip 500. That is, the aperture 706 may be used to secure the small air hose clip 700 to the nailer via the pneumatic barb provided on the nailer.

In a further embodiment, the small air hose clip 700 may be modified such that the first section is configured to mount to the clip area of a conventional battery powered screw gun. That is, the existing clip on the screw gun may be replaced by screw gun clip 800. In all respects screw gun clip 800 is identical to small air hose clip 700, except the first section 808 of the connection plate 802 is modified. That is, the attachment portion 804 is identical to attachment portion 704. Again, other configurations and dimensions may be preferred.

Here, the first section 808 includes a bent portion 848 which includes a planar capture portion 850 designed to be inserted and captured within the confines of a conventional battery powered screw gun receptacle. The capture portion 850 is parallel to the connection plate 802. The bent portion 848 includes an aperture 852 through a surface 854 which is perpendicular to the capture portion 850. Thus, when the capture portion 850 is inserted into the battery powered screw gun, a fastener such as a screw or bolt may be used to secure the screw gun clip 800 to the battery powered screw gun, which is provided with a threaded barrel for this purpose.

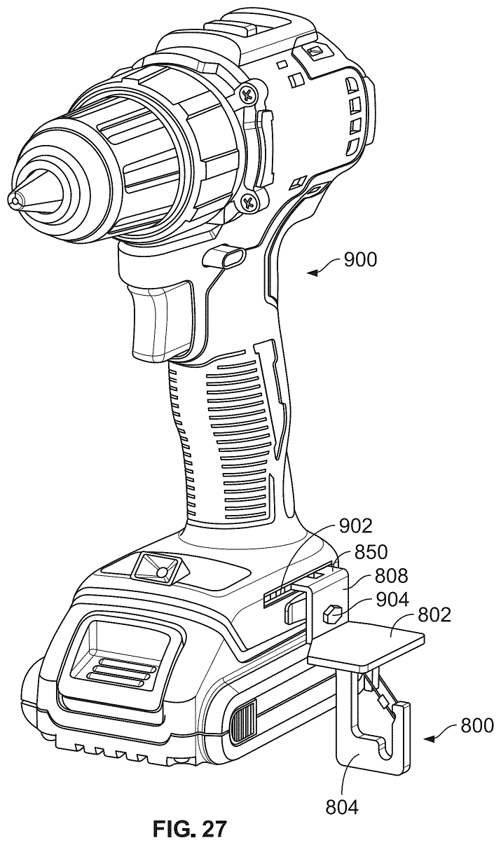

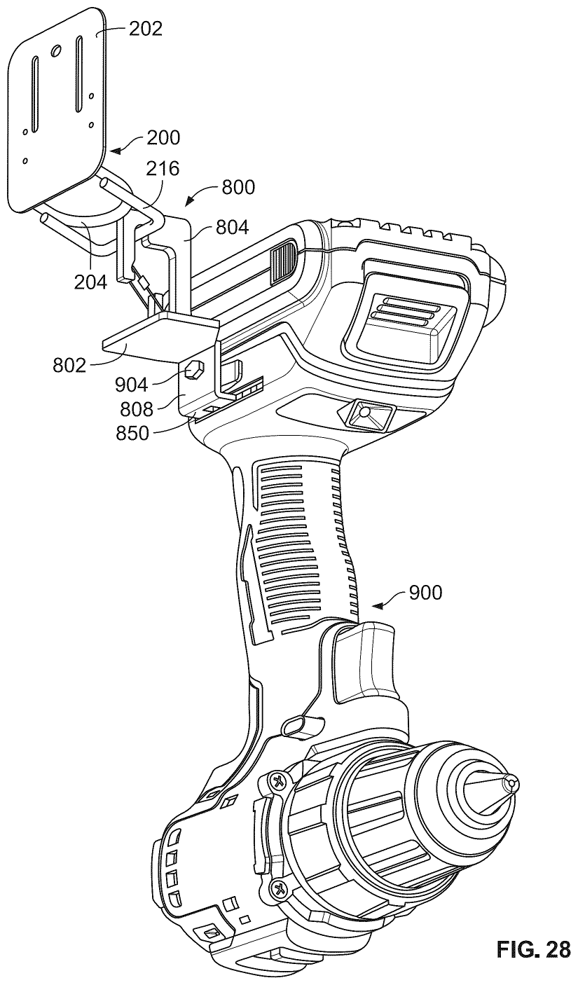

FIG. 27 shows the screw gun clip 800 attached to a battery powered screw gun 900 while FIG. 28 shows use of the screw gun clip with the double hammer holder 200 of FIG. 2. Importantly, the powered screw gun 900 includes a slot 902 accepting entry of the capture portion 850 of the screw gun clip 800 as well as a threaded barrel (not shown) in which a fastener 904 may be used to secure the first section 808 of the connection plate 802 to the screw gun.

While typically manufactured from metal, the various bars of the invention may be manufactured from other materials, such as plastic. The bars preferably have circular cross sections, but other configurations may also be suitable. These configurations include square and oval or others, or combinations of round, square, and oval or others. The bars need not all be the same configuration or size. Similarly, while typically manufactured from leather, the various backers may be manufactured from other materials, such as thermoplastic acrylic-polyvinyl chloride.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A tool support device comprising:
a backer having a planar surface;
a hammer support bar, said hammer support bar having a first portion extending perpendicular to said planar surface of said backer and a second portion attached to said planar surface such that said hammer support bar and said backer form an open hammer support area;
an accessory support bar extending parallel to said first portion of said hammer support bar and being associated with said hammer support bar, said accessory support bar and said open hammer support bar forming an open accessory area outside the bounds of said open hammer support area;
wherein said open hammer support area is adapted to support the head of a hammer while the handle of the hammer is passed therethrough and said open accessory area is adapted to permit a clip to be clipped onto said accessory support bar.

2. The tool support device of claim 1, wherein said first portion of said hammer support includes a semicircular section.

3. The tool support device of claim 2, wherein said accessory support bar is U-shaped.

4. The tool support device of claim 3, wherein said accessory support bar is welded to said hammer support bar.

5. The tool support device of claim 4, wherein said first portion of said hammer support bar has a circular cross section.

6. The tool support device of claim 1, wherein said hammer support bar and said accessory support bar are monolithic.

7. The tool support device of claim 1, further comprising a tertiary support bar, said tertiary support bar spanning between said hammer support bar and said accessory support bar to divide said open accessory area into an open whacker area and a tertiary open area.

8. The tool support device of claim 7, wherein said open whacker area is larger than said tertiary open area.

9. The tool support device of claim 1, further comprising a clip, said clip comprising:
a connection portion for connecting to a tool and an attachment portion for attaching to said accessory support bar, said attachment portion having an open area enclosable by a spring bar forming a gate, said spring bar having a biased closed position enclosing said open area.

10. The tool support device of claim 9, wherein said spring bar may be moved into an open position allowing access to said open area.

11. The tool support device of claim 10, wherein said connection portion includes an aperture sized and configured to accept a threaded portion of a pneumatic air barb of the tool.

12. The tool support device of claim 11, wherein said attachment portion includes an extension member forming a spike, said spike extending into said open area.

13. The tool support device of claim 10, wherein said connection portion is sized and configured to replace a belt clip of a conventional tool, including having a portion sized and configured for insertion into a slot of the conventional tool and an aperture sized and configured to accept a fastener insertable into an existing threaded barrel of the conventional tool.

14. The tool support device of claim 10, wherein said attachment portion includes a semicircular capture portion for capturing said accessory support bar.

15. The tool support device of claim 10, wherein said attachment portion includes a built up area forming a semicircular capture portion for capturing said accessory support bar.

16. A kit for supporting a plurality of tools upon a user's belt, said kit comprising:
a support device, said support device comprising a backer having a planar surface; a hammer support bar, said hammer support bar having a first portion extending perpendicular to said planar surface and a second portion attached to said planar surface such that said hammer support bar and said backer form an open hammer support area; and an accessory support bar extending parallel to said first portion of said hammer support bar and being associated with said hammer support bar, said accessory support bar and said open hammer support bar forming an open accessory area outside the bounds of said open hammer support area;
a clip, said clip comprising a connection portion for connecting to a tool and an attachment portion for attaching to said accessory support bar, said attachment portion having an open area enclosable by a spring bar forming a gate, said spring bar having a default closed position enclosing said open area and an open position permitting access to said open area;
wherein said open hammer support area is adapted to support the head of a hammer while the handle of the hammer is passed therethrough and said open accessory area is adapted to permit the clip to be secured onto said accessory support bar by moving said spring bar into the open position.

17. The kit of claim 16, wherein said support device further comprises a tertiary support bar dividing said open accessory area into two areas.

18. The kit of claim 17, wherein said tertiary support bar splits said open accessory area into two unequally sized areas.

19. The kit of claim 17, wherein said connection portion of said clip includes an aperture sized and configured to accept a threaded portion of a pneumatic air barb of a conventional tool.

20. The kit of claim 17, wherein said connection portion is sized and configured to replace a belt clip of a conventional tool, including having a portion sized and configured for insertion into a slot of the conventional tool and an aperture sized and configured to accept a fastener insertable into an existing threaded barrel of the conventional tool.

21. A tool clip, said tool clip comprising:
a connection portion for connecting to a tool;
an attachment portion for attaching said tool clip to a component, said attachment portion having an open area enclosable by a spring bar forming a gate, said spring bar having a biased closed position enclosing said open area.

22. The tool clip of claim 21, wherein said connection portion includes an aperture sized and configured to accept a threaded portion of a pneumatic air barb of a tool such that said connection portion of said tool clip may be sandwiched between a tool and a washer portion of the pneumatic air barb to secure said connection portion to the tool.

23. The tool clip of claim 21, wherein said connection portion comprises:
a flattened capture portion sized and configured to be inserted into a receptacle of a tool;
an aperture through a surface perpendicular to said flattened capture portion, said aperture sized and configured to accept a fastener securable within an existing threaded barrel of the tool to secure said capture portion to the tool.
